(19) United States
(12) Patent Application Publication
(10) Pub. No.: US 2021/0205161 A1
(43) Pub. Date: Jul. 8, 2021

(54) PATIENT MOVEMENT SYSTEM

(71) Applicant: Veronica R. Papa, San Diego, CA (US)

(72) Inventor: Veronica R. Papa, San Diego, CA (US)

(21) Appl. No.: 16/736,806

(22) Filed: Jan. 7, 2020

(51) Int. Cl. A61G 7/10; B60B 33/02

(52) U.S. Cl. CPC A61G 7/1046; A61G 7/1059; A61G 2203/10; B60B 33/028; A61G 7/1074; A61G 7/1051

(57) ABSTRACT

A system for moving a patient is presented. The system is useful for providing transfer of a user from one location to another location. Also, the system is useful for lifting a user and moving the user to a side or from side to side to allow the changing of sheets or other bedding material or for performing normal tasks to encourage a patient for their recovery. The system may be used to lift and move a patient to the toilet, into/out of a bed, into or out of a vehicle, a wheelchair, etc. The system is adjustable in length, width, and height and stackable. The system may be coupled to another of the system for providing transport of more than one person simultaneously. Further, the system is motorized to move the system in a forward/backward direction and can monitor the patient or provide the patient easy access to control the device. The control is either hardwired and/or wireless connectivity to an app on a computing device.

### FIELD OF THE INVENTION

This invention relates to patient moving systems. More particularly, it relates to moving systems with slings.

### BACKGROUND

A wide variety of products have been designed to move objects from one location to another and, in particular, transfer mobility-impaired individuals such as patients. In a hospital setting, patients must often be transported from their beds to an examination table or operating table, and back again. Basic devices for transferring patients include stretchers that are carried manually by two attendants, and wheeled gurneys that can more easily be handled by a single attendant.

There can still be problems, however, in getting a patient from a bed or other support surface onto a stretcher or gurney. If the patient is cooperative and not injured or disabled, it is a simple matter for the individual to slide over to the gurney with the assistance of a nurse, but if the patient is unconscious or has a disability or an injury (e.g., a broken bone) that might be worsened by movement, then great care must be taken in transferring the patient from the bed to the gurney. This problem is exacerbated when the patient is unusually heavy.

One solution to this problem is to slide a tray or sheet under the person and then, after the person is resting atop it, pull the tray or sheet off the bed and onto the gurney. A rigid tray can be forcibly inserted between the patient and the bed, and a sheet can be incrementally pushed under the person by first rocking him away from the gurney and then rocking back toward the gurney as the sheet is drawn under. This approach can still be difficult if the patient is uncooperative (i.e., unconscious), and can further be very uncomfortable even if the patient is cooperative, due to the frictional engagement of the tray with the body or the lack of firm support by the sheet.

Some transfer devices incorporate a rigid tray into the gurney that can move to the side and slide under a patient, and then slide back (while supporting the patient) to a centered position for transportation. In a further variation on this concept, the transfer device may use counter-rotating, endless belts to substantially eliminate friction against both the patient and the bed as support trays crawl under the patient. In one example, a first endless belt surrounds a set of upper trays and a second endless belt surrounds a set of lower trays, so the portions of the belts that are in contact (between the upper and lower tray sets) move in the same direction at the same rate as they counter-rotate. As the trays are inserted under the patient, the belt on the upper tray everts outwardly at the same rate as the translational movement of the trays to crawl under the patient without introducing any significant friction, and the belt on the lower tray similarly everts along the bed sheet. Once the patient is supported by the trays, the entire tray assembly is raised off the bed and the device can be rolled on casters to transport the patient.

There are still several serious problems with the counter-rotating belt designs. The entire transfer device (including the base and support members) moves as the trays are inserted under the patient, and the base must extend under the bed or table in order to prevent the device from tipping over when the patient is carried. Because of this limitation, such devices cannot be used in all settings, i.e., wherein there is insufficient clearance space under the bed or table (a situation becoming more common as more accouterments are added to beds and tables that occupy the space underneath). These devices further only allow loading and unloading along one side of the device, which can present problems when the patient is not suitably oriented (head-to-feet) on the device with respect to the bed or table. These Design are also not particularly comfortable as there is only a thin layer of the belt interposed between the patient and the hard surface of the metal support trays. Moreover, hospitals are becoming increasingly concerned with potential contamination from patient fluids, and the prior art belt-type transfer devices are difficult if not impossible to properly clean.

In light of the foregoing, it would be desirable to devise an improved patient transfer device that provided more flexibility in deployment while still being easy to operate and maneuver. It would be further advantageous if the device were more comfortable for the patient, yet could still maintain the patient in a stabilized manner during transport.

### BRIEF DESCRIPTION OF THE DRAWINGS

FIG. 1A is an illustrated view of an exemplary patient movement system for moving a patient.

FIG. 1B is an illustrated view of a compact position of the exemplary patient movement system shown in FIG. 1A.

FIG. 1C is an illustrated view of an outward position of the exemplary patient movement system shown in FIG. 1A.

FIG. 2 is an illustrated close up top view of the exemplary patient movement system shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

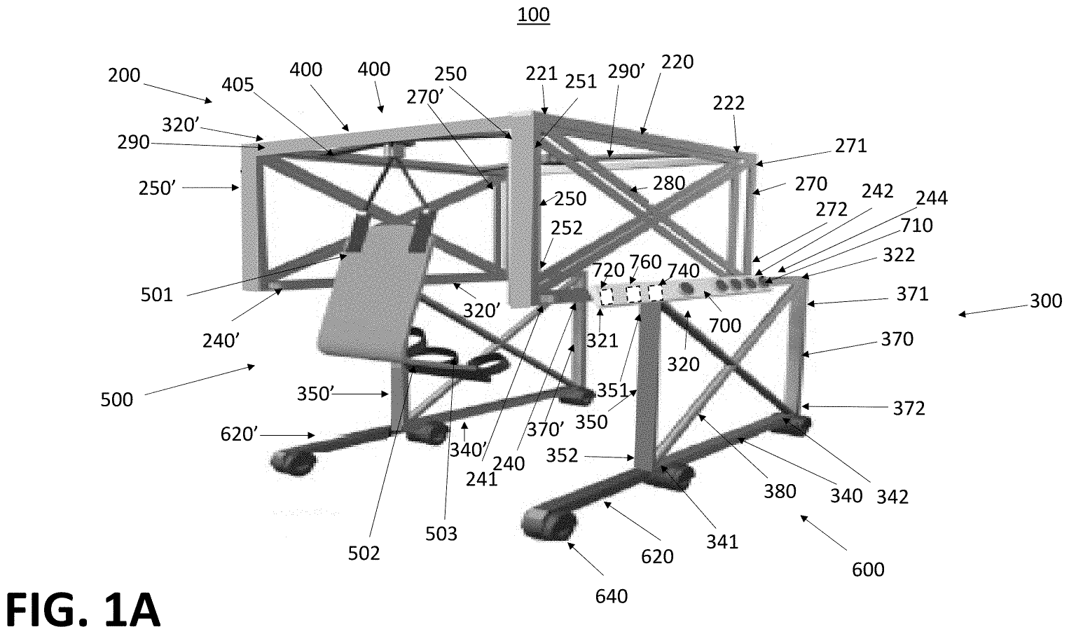

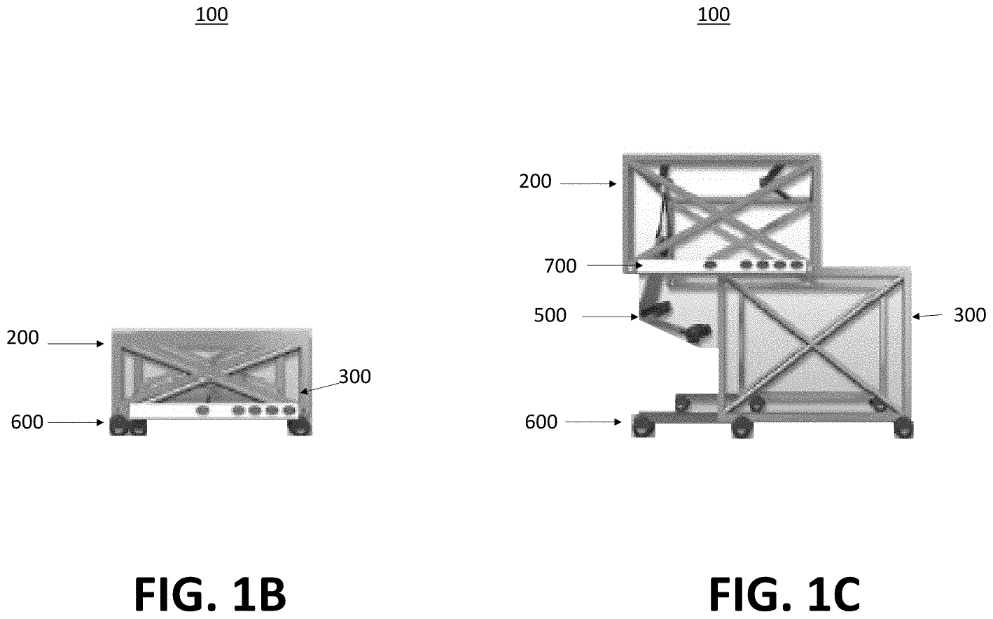

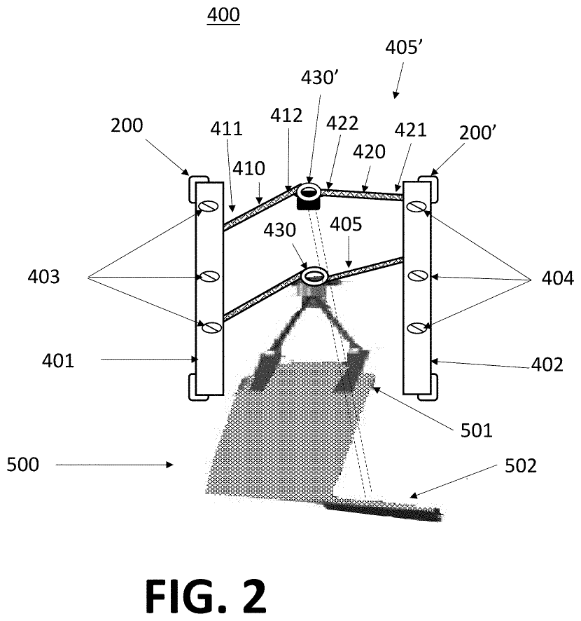

Referring to FIG. 1A, FIG. 1B, FIG. 1C and FIG. 2, a patient movement system 100, also known as the, “All in One Individual Lift,” for moving a user from side to side is presented. The system 100 is useful for providing transfer of a user from one location to another location. Also, the system 100 is useful for lifting a user and moving the user to a side or from side to side to allow the changing of sheets or other bedding material or for performing normal tasks to encourage a patient for their recovery. The system 100 may be used to lift and move in tight places, including, but not limited to, a toilet, into/out of a bed, into or out of a vehicle, a wheelchair, etc.

The system 100 has a top frame 200 and a bottom frame 300, a wheel assembly 600 and a seat 500. The system 100 preferably transports a single person, however, more than one system 100 may be coupled together to provide transport for two or more people. The system 100 is preferably stackable, thus the transporting of more than one system 100 can be compact and save on space when stored or moved.

The top frame 200 may be made of any material such as preferably surgical plastic, aluminum, high-density poly-ethylene, etc. The top frame 200 preferably supports three hundred fifty pounds (350 lbs.), but other supported weight is hereby contemplated such as, but not limited to, four-hundred pounds (400 lbs.), two hundred fifty pounds (250 lbs.), etc. The top frame 200 may be adjustable to forward/backward, up/down or may be non-adjustable.

The top frame 200 has two top bars 220, 220′, two bottom bars 240, 240′, two first side posts 250, 250′ and two second side posts 270, 270′. Each of the top bars 220, 220′ of the top frame 200 have a proximal end 221 and a distal end 222.

Each of the first side posts 250, 250′ of the top frame 200 have a proximal end 251 and a distal end 252. Each of the second side post 270, 270′ of the top frame 200 have a proximal end 271 and a distal end 272. Each of the two bottom bars 240, 240′ of the top frame 200 have a proximal end 241, a distal end 242 and a center portion 243.

The proximal end 221 of the top bars 220, 220′ is coupled to the proximal end 251 of the first side posts 250, 250′. The proximal end 241 of the bottom bars 240, 240′ is coupled to the distal end 252 of the first side posts 250, 250′. The distal end 222 of the top bars 220, 220′ is coupled to the proximal end 271 of the first side posts 270, 270′. The distal end 242 of the bottom bars 240, 240′ is coupled to the distal end 272 of the second side posts 270, 270′.

A plurality of interior bars 280, 280′ are coupled diagonally in each of the top frames 200. A plurality of cross bars 290, 290′ couple the two top bars 220, 220′.

A top support 400 is coupled to a top 244 of the top frame 200. The top support 400 is further shown in detail in FIG. 2.

The top support 400 has a first support bar 401, a second support bar 402 and one or more seat support bars 405, 405′. Each of the seat support bars 405, 405′ has a first push pull tube 410, a second push pull tube 420 and a bell crank 430, 430′. The top support 400 is preferably made of hospital grade steel, but other materials may be used as desired. The seat 500 is coupled to the one or more of the seat support bars 405. A first of the seat support bars 405 is preferably coupled to an upper portion 501 of the seat 500. Alternative and/or additionally, the bell crank 530′ of a second of the seat support bars 405′ may be coupled to a lower portion 502 of the seat 500.

The first pull tube 410 has a proximal end 411 and a distal end 412. The second pull tube 420 has a proximal end 421 and a distal end 422. The bell crank 430 is a circular fulcrum that has a locking mechanism to lock the first pull tube 410 in a first position and the second pull tube 420 in a second position.

The first support bar 401 is securely coupled to the top 244 of a first of the top bars 220 of the top frame 200. The second support bar 402 is securely coupled to the top 244 of a second of the top bars 200′ of the top frame 200.

The first support bar 401 has a plurality of coupling ports 403. The plurality of coupling ports 403 are for coupling the proximal end 411 of the first pull tube 410 to the first support bar 401 at various points. The second support bar 402 has a plurality of coupling ports 404. The plurality of coupling ports 404 are for coupling the proximal end 421 of the second pull tube 420 to the second support bar 402 at various points. Any and/or all of the seat support bars 405, 405′ are removable from and/or repositionable from the plurality of top support 400.

The distal end 412 of the first pull tube 410 is securely and movably coupled to the bell crank 430. The distal end 422 of the second pull tube 420 is securely and movably coupled to the bell crank 430. The movability of the coupling with the bell crank 430 allows for the adjustment of the seat 500 to a desired position and height.

The upper portion 501 of the seat 500 is coupled to the bell crank 430 of one of the seat support bars 405, 405′ to a predetermined position for the seat 500. The lower portion 502 of the seat 500 may be coupled to the bell crank 430′ of a second of the seat support bars 405′ to provide further support for the patient.

The bottom frame 300 may be made of any material such as preferably surgical plastic, aluminum, high-density poly-ethylene, etc. The bottom frame 300 preferably supports three hundred fifty pounds (350 lbs.), but other supported weight is hereby contemplated such as, but not limited to, four-hundred pounds (400 lbs.), two hundred fifty pounds (250 lbs.), etc. The bottom frame 300 may be adjustable to forward/backward, up/down or may be non-adjustable.

The bottom frame 300 has two top bars 320, 320′, two bottom bars 340, 340′, two first side posts 350, 350′ and two second side posts 370, 370′. Each of the top bars 320, 320′ of the bottom frame 300 have a proximal end 321 and a distal end 322. Each of the bottom bars 240, 240′ of the top frame 200 are movably coupled to top bars 320, 320′ of the bottom frame 300.

Each of the first side posts 350, 350′ of the bottom frame 300 has a proximal end 351 and a distal end 352. Each of the second side post 370, 370′ of the bottom frame 300 has a proximal end 371 and a distal end 372. Each of the two bottom bars 340, 340′ of the bottom frame 300 has a proximal end 341 and a distal end 342.

The proximal end 321 of the top bars 320, 320′ is coupled to the proximal end 351 of the first side posts 350. The proximal end 341 of the bottom bars 340, 340′ are coupled to the distal end 352 of the first side posts 350, 350′. The distal end 322 of the top bars 320, 320′ is coupled to the proximal end 371 of the first side posts 270, 270′. The distal end 342 of the bottom bars 340, 340′ are coupled to the distal end 372 of the second side posts 370, 370′.

A plurality of interior bars 380 are coupled diagonally in each of the bottom frames 300.

A control panel 700 is securely coupled to at least one of the top bars 320. The control panel 700 has a plurality of control buttons 710, a power source 720, a computing device 740 and a motor 760. The computing device 740 is communicatively coupled to the motor 760 and the control buttons 710. The power source 720 is electrically coupled to the computing device 740 and the motor 760. The power source 720 is preferably a rechargeable battery, however other types of power sources are hereby contemplated, including, but not limited to, AC/DC, disposable battery, solar, etc.

The plurality of control buttons 710 are communicatively coupled to the computing device 740 and when one of the control buttons is actuated, a signal is communicated to the computing device 740. The control buttons 710 may be actuated to cause movement of the top frame 200 of the system 100. The control buttons 710 may cause the top frame 200 to move in an upward direction, a downward direction, a forward direction and/or a backward direction.

When a signal from the control buttons 710 is communicated to the computing device 740, the computing devices 740 determines the movement desired of the top frame 200. The computing device 740 being communicatively coupled to the motor 760, directs the motor 760 to be actuated and to move the top frame 200 in the determined movement. Releasing of the actuated control button 710 sends a signal to the computing device 740 to cease movement of the top frame 200 by directing the motor 760 to stop.

As can be seen in FIG. 1B, the top frame 200 has been moved in a downward direction and is in a condensed condition to aid in storage and transport of the system 100.

In FIG. 1C, the top frame 200 has been moved in a forward direction 200 allowing for a different location of the seat 500. This position of the top frame 200 may aid in the patient to be placed onto the seat 500, to be removed from the seat 500 or have easier access to a bathroom facility.

Each of the plurality of wheel assemblies 600 has a plurality of wheel bars 620, 620′ and a plurality of wheels 640. Each of the foot assemblies 600 is securely coupled to one of the bottom bars 340, 340′ of the bottom frame 300. The plurality of wheel assemblies 600 are useful for secure, safe and fast movement of the patient or to aide in the patient using the system 100 in rehabilitation or ability to move around.

At least one of the wheels 640 is coupled to one of the wheel bars 620, 620′ of the plurality of wheel assemblies 600. Preferably, the wheels 640 are able to swivel in a 360° direction. Each of the wheel assemblies 640 is communicatively coupled to the power source 720 and the motor 760. At least one of the control buttons 740 actuates the movement of the wheels 640 in a direction determined by the computing device 710.

The seat 500 is useful for securely carrying or coupling around a user to lift, transfer or move the user from side to side, up and down, etc. The seat 500 is preferably a sling. The seat 500 is made of a soft, pliable but strong material, such as plastic, cloth, etc. The seat support bars 405 are useful as an adjusting bar for the seat 500. The seat 500 is preferably adjustable in length and width but may be static if so desired.

The seat 500 is a chair structure with a belt 503, but other types of apparatus are hereby contemplated including, but not limited to, baby seat, normal seat, armed seat, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for moving a patient, the system comprising:
a top frame, the top frame comprising:
two (2) first side posts, two second side posts, a top bar and a bottom bar;
the top bar securely coupled to the first side post, and the top bar securely coupled to the second side post;
the bottom bar securely coupled to the first side post, and the bottom bar securely coupled to the second side post;
a seat support bar, the seat bar being movably coupled to the top bar;
a seat, the seat for holding the patient, wherein the seat being movably coupled to the top;
a bottom frame, the bottom frame comprising:
two (2) first side posts, two second side posts, a top bar and a bottom bar;
the top bar securely coupled to the first side post, and the top bar securely coupled to the second side post;
the bottom bar securely coupled to the first side post, and the bottom bar securely coupled to the second side post;
the top bar securely coupled to the first side post, and the top bar securely coupled to the second side post;
the bottom bar securely coupled to the first side post, and the bottom bar securely coupled to the second side post;
a plurality of wheel assemblies, the wheel assemblies comprising:
a plurality of wheel bars, the wheel bars being coupled to the bottom bar of the bottom frame;
a plurality of wheels, the plurality of wheels being coupled to the wheel bars;
a control panel, the control panel having a computing device, a power source and a plurality of buttons, the control panel coupled to the top bar of the bottom frame; and
wherein actuating one of the plurality of buttons being for moving of the system in a determined movement by the computing device.

2. The system of claim 1, wherein the system further comprising
a top support, the top support for stabilizing the system, wherein the top support has one or more seat support bars, wherein each of the seat support bars having a first push pull tube, a second push pull tube and a bell crank; and
the first pull tube being coupled to the bell crank and the first pull tube being coupled to a first of the top bars of the top frame; and the second pull tube being coupled to the bell crank and the second pull tube being coupled to a second of the top bars of the top frame.

3. The system of claim 1, wherein the top support further comprising:
a plurality of support bars, a first of the support bars being securely coupled to a first of the top bars of the top frame.

4. The system of claim 1, wherein the system further comprising:
a first crossbar, the first crossbar being coupled to the first side post and the second side post; and
a second crossbar, the second first crossbar being coupled to the first side post and the second side post, wherein the first crossbar and the second crossbar intersect.

5. The system of claim 1, wherein the system further comprising:
a wheel assembly, the wheel assembly having a wheel bar and one or more wheels, wherein the one or more wheels being coupled to the wheel bar, and wherein the wheel bar being securely coupled to the bottom bar of the bottom frame.

6. The system of claim 5, wherein the wheels being 360° swivel locking wheels.

7. The system of claim 5, wherein the wheels being automatically movable.

8. The system of claim 1, wherein the seat being a sling.

9. The system of claim 1, wherein a height being adjusted by the computing device of the control panel.

10. The system of claim 1, wherein the system being supportive of three-hundred fifty (350) pounds.

11. The system of claim 1, wherein the top frame being adjustable in a forward and backward direction.

12. The system of claim 1, wherein the top frame being adjustable in an up and a down direction.

13. The system of claim 1, wherein the wheels being controlled by the motor receiving signals from the computing device.

14. The system of claim 1, wherein a length being adjusted the length by the computing device of the control panel.

15. The system of claim 1, wherein the system is stackable.

16. The system of claim 1, wherein the system being coupled to another of the system for providing transport of more than one person simultaneously.

17. The system of claim 1, wherein the bottom bar, the bottom bar being coupled substantially near the distal end of the first side post and the second side post.

18. The system of claim 1, wherein the top frame further comprising:
a plurality of cross bars, the cross bar being coupled between the first side bar and the second side bar.

19. The system of claim 1, wherein the bottom frame further comprising:
a plurality of cross bars, the cross bar being coupled between the first side bar and the second side bar.
